(19) United States
(12) Patent Application Publication
(10) Pub. No.: US 2025/0234343 A1
(43) Pub. Date: Jul. 17, 2025

(54) METHODS AND APPARATUS FOR POWER DOMAIN MULTIPLEXING OF COMMUNICATION AND SENSING SIGNALS

(71) Applicant: Huawei Technologies Co., Ltd., Shenzhen (CN)

(72) Inventors: Shahram Shahsavari, Ottawa (CA); Alireza Bayesteh, Brossard (CA)

(21) Appl. No.: 19/009,443

(22) Filed: Jan. 3, 2025

Related U.S. Application Data
(63) Continuation of application No. PCT/CN2022/104203, filed on Jul. 6, 2022.

(51) Int. Cl. H04W 72/044; G01S 7/00

(52) U.S. Cl. CPC H04W 72/0473; G01S 7/006

(57) ABSTRACT

Aspects of the present application relate to multiplexing communication signals and sensing signals in the power domain. An indication that a particular unit of time-frequency resources, among a plurality of units of time-frequency resources, has been allocated to sensing and communication may be transmitted. Subsequently, an indication of a sensing waveform configuration for the particular unit of time-frequency resources may be transmitted. The sensing waveform configuration may include an indication of an allocation of power to a radio frequency (RF) sensing waveform in an integrated waveform. Then a signal according to the integrated waveform may be transmitted. The integrated waveform may include the RF sensing waveform and an RF communication waveform. Additionally, power in the integrated waveform may allocated to the RF sensing waveform in accordance with the sensing waveform configuration.

### CROSS-REFERENCE TO RELATED APPLICATION

This application is a continuation of International Application No. PCT/CN2022/104203, filed on Jul. 6, 2022, the disclosure of which is hereby incorporated by reference in its entirety.

### TECHNICAL FIELD

The present disclosure relates, generally, to multiplexing of communication and sensing signals and, in particular embodiments, to carrying out the multiplexing in the power domain.

### BACKGROUND

Data communication has been an objective of several generations of wireless communication systems. In wireless data communication, bits of information are conveyed from a transmitter to a receiver through a wireless medium. The wireless medium may be called a wireless channel. Various changes may be seen to have occurred in a signal that has travelled through a wireless channel. A received signal may differ from a transmitted signal due to, inter alia, a delay and a frequency shift. Indeed, it may be shown that the delay, which differentiates the transmitted signal from the received signal, is proportional to the distance the signal traverses, in the wireless channel, from the transmitter to the receiver.

Additionally, it may be shown that movements of the transmitter, the receiver and objects in the environment lead to a frequency shift in the received signal relative to the transmitted signal. This frequency shift is known as a Doppler shift. Several applications, such as object localization applications, employ an estimation of delay, angle and Doppler shift. As a result, various approaches have been developed, in radar literature and other sensing literature, to estimate delay, angle and Doppler shift.

### SUMMARY

Aspects of the present application relate to multiplexing communication signals and sensing signals in the power domain. An indication that a particular unit of time-frequency resources, among a plurality of units of time-frequency resources, has been allocated to sensing and communication may be transmitted. Subsequently, an indication of a sensing waveform configuration for the particular unit of time-frequency resources may be transmitted. The sensing waveform configuration may include an indication of an allocation of power to a radio frequency (RF) sensing waveform in an integrated waveform. Then a signal according to the integrated waveform may be transmitted. The integrated waveform may include the RF sensing waveform and an RF communication waveform. Additionally, power in the integrated waveform may allocated to the RF sensing waveform in accordance with the sensing waveform configuration.

Sensing and communication are known to have different objectives. Accordingly, the task of designing a waveform for integrated sensing and communication may be shown to lead to trade-offs. To address such trade-offs, existing approaches may be shown to involve complex optimizations.

Aspects of the present application relate to a scheme for designing and using a waveform for integrated sensing and communication. The scheme may be shown to be efficient, in that the scheme may be used in scenarios where communication and sensing use overlapped resources. The scheme may also be shown to be flexible, in that the scheme may be shown to achieve objectives related to both communication and sensing. The scheme may be shown to have a relatively low complexity. That is, the scheme may be shown to operate without requiring any heavy online optimizations.

Aspects of the present application may be shown to provide a low-complexity approach for integrating sensing and communication waveform design with overlapped resources. By power domain multiplexing of sensing waveforms and communication waveforms, an integrated waveform may be obtained and used for both sensing and communication. It may be shown that the proposed scheme does not require complex optimization. Notably, however, the proposed scheme also does not preclude such optimizations. Accordingly, the proposed scheme may be shown to provide flexibility for deploying an integrated sensing and communication system.

Conveniently, aspects of the present application may be shown to provide a framework for a flexible waveform design for integrated sensing and communication systems. In this framework, relatively high data rate waveforms may be used for data communication and sequences with relatively good correlation properties may be used for sensing. The communication waveform need not be relied upon for sensing or vice versa. Aspects of the present application may be shown to provide efficient resource allocation. In the framework, overlapped resource units may be used for both communication and sensing. The relatively low-complexity of implementation may be considered a feature, because complex optimization for generating an integrated sensing and communication waveform need not be performed. Of course, while not requiring complex optimization, the framework also does not preclude such optimizations. Accordingly, it may be found that the framework provides flexibility for deploying an integrated sensing and communication system.

Further conveniently, the aspects of the present application that relate to proposed power-domain waveform multiplexing may be shown to support legacy data communication approaches that are based on pilots for channel estimation. Additionally, it may be shown that communication-only user equipment may benefit from the presence of a sensing waveform in an integrated sensing and communication waveform for those instances wherein a pilot is not present in the communication waveform for the purpose of channel estimation. Aspects of the present application relate to use of a shared part, a private part and a reference part of a communication waveform so as to improve sensing performance.

Further conveniently, the aspects of the present application that relate to using the sensing signal to send a part of the communication data may be shown to reduce overhead by removing one of the parts (shared part) of the communication waveform. It is recognized that this convenience may be considered to come at a cost of a more complex receiver structure.

According to an aspect of the present disclosure, there is provided a method. The method includes transmitting, by a base station to a user equipment (UE), an indication that a particular unit of time-frequency resources, among a plurality of units of time-frequency resources, has been allocated to sensing and communication. The method further includes transmitting, by the base station to the UE, an indication of a sensing waveform configuration for the particular unit of time-frequency resources. The sensing waveform configuration includes an indication of an allocation of power to a radio frequency (RF) sensing waveform in an integrated waveform. The method further includes transmitting, by the base station, a signal according to the integrated waveform, wherein the integrated waveform includes the RF sensing waveform and an RF communication waveform and wherein power is allocated to the RF sensing waveform in accordance with the sensing waveform configuration.

According to an aspect of the present disclosure, there is provided an apparatus. The apparatus includes a memory storing instructions and a processor. The processor may be caused, by executing the instructions, to cause the apparatus to transmit an indication that a particular unit of time-frequency resources, among a plurality of units of time-frequency resources, has been allocated to sensing and communication. The processor further causes the apparatus to transmit an indication of a sensing waveform configuration for the particular unit of time-frequency resources. The sensing waveform configuration includes an indication of an allocation of power to a radio frequency (RF) sensing waveform in an integrated waveform. The processor further causes the apparatus to transmit a signal according to the integrated waveform, wherein the integrated waveform includes the RF sensing waveform and an RF communication waveform and wherein power is allocated to the RF sensing waveform in accordance with the sensing waveform configuration.

According to an aspect of the present disclosure, there is provided a method. The method includes receiving, by a user equipment (UE) from a base station, an indication that a particular unit of time-frequency resources, among a plurality of units of time-frequency resources, has been allocated to sensing and communication. The method further includes receiving, by the UE from the base station, an indication of a sensing waveform configuration for the particular unit of time-frequency resources. The sensing waveform configuration includes an indication of an allocation of power to a radio frequency (RF) sensing waveform in an integrated waveform. The method further includes receiving, by the UE from the base station, a signal according to the integrated waveform, wherein the integrated waveform includes the RF sensing waveform and an RF communication waveform and wherein power is allocated to the RF sensing waveform in accordance with the sensing waveform configuration.

According to an aspect of the present disclosure, there is provided an apparatus. The apparatus includes a memory storing instructions and a processor. The processor may be caused, by executing the instructions, to cause the apparatus to receive an indication that a particular unit of time-frequency resources, among a plurality of units of time-frequency resources, has been allocated to sensing and communication. The processor further causes the apparatus to receive an indication of a sensing waveform configuration for the particular unit of time-frequency resources. The sensing waveform configuration includes an indication of an allocation of power to a radio frequency (RF) sensing waveform in an integrated waveform. The processor further causes the apparatus to receive a signal according to the integrated waveform, wherein the integrated waveform includes the RF sensing waveform and an RF communication waveform and wherein power is allocated to the RF sensing waveform in accordance with the sensing waveform configuration.

Optionally, in an example of any of the preceding aspects, the RF sensing waveform comprises a frequency-modulated continuous wave waveform. Optionally, the sensing waveform configuration comprises an indication of a chirp rate. Optionally, in an example of any of the preceding aspects, the RF sensing waveform comprises a fractional Fourier transform waveform.

Optionally, in an example of the first two aspects, the apparatus or base station further generates a baseband sensing waveform, and constructs the RF sensing waveform from the baseband sensing waveform. Alternatively, the apparatus or base station further directly generates the RF sensing waveform.

Optionally, in an example of the first two aspects, the apparatus or base station further generates the integrated waveform by adding the RF communication waveform to the RF sensing waveform, wherein power is allocated to the RF sensing waveform in accordance with the sensing waveform configuration. Alternatively, the apparatus or base station further generates the integrated waveform by adding a baseband communication waveform to a baseband sensing waveform to form a baseband integrated waveform, wherein power is allocated to the baseband sensing signal in accordance with the sensing signal configuration, converting the baseband integrated waveform to an RF integrated waveform.

Aspects of the present disclosure also include an apparatus comprising a processor configured to cause the apparatus to perform any of the preceding methods. Aspects of the present disclosure also include a computer-readable storage medium comprising instructions which, when executed by a computer, cause the computer to carry out any of the preceding methods.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates an example environment wherein a transmit receive point transmits a beam that covers a plurality of user equipment;

FIG. 7 illustrates example steps in a method of power domain multiplexing of communication waveforms (signals) and sensing waveforms (signals), in accordance with aspects of the present application;

FIG. 8 illustrates an example representation of time-frequency resource allocation information, in accordance with aspects of the present application;

FIG. 9 illustrates, as a block diagram, an example structure for a receiver suitable for an integrated sensing and communication capable one of the plurality of user equipment in FIG. 6, in accordance with aspects of the present application;

FIG. 10 illustrates, as a block diagram, an example structure for a receiver suitable for a communication-only capable one of the plurality of user equipment in FIG. 6, in accordance with aspects of the present application;

FIG. 11 illustrates, as a block diagram, an example receiver architecture suitable for use in a communication-only capable one of the plurality of user equipment in FIG. 6, in accordance with aspects of the present application;

FIG. 12 illustrates, in a block diagram, an arrangement of modules for receiving a communication waveform with multiple parts suitable for use in one of the plurality of user equipment in FIG. 6, in accordance with aspects of the present application;

FIG. 13 illustrates, in a block diagram, a sensing receiver and channel reconstruction module for use in one of the plurality of user equipment in FIG. 6, where the user equipment is configured to receive shared communication information symbols through the use of sensing waveforms, in accordance with aspects of the present application;

FIG. 14A illustrates a sensing waveform (signal) implemented as a single chirp signal with a chirp rate, in accordance with aspects of the present application;

FIG. 14B illustrates a sensing waveform (signal) implemented as a plurality of chirp signals in the time domain, in accordance with aspects of the present application; and

FIG. 14C illustrates a sensing waveform (signal) implemented as a plurality of chirp signals in the frequency domain using fractional Fourier transform, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

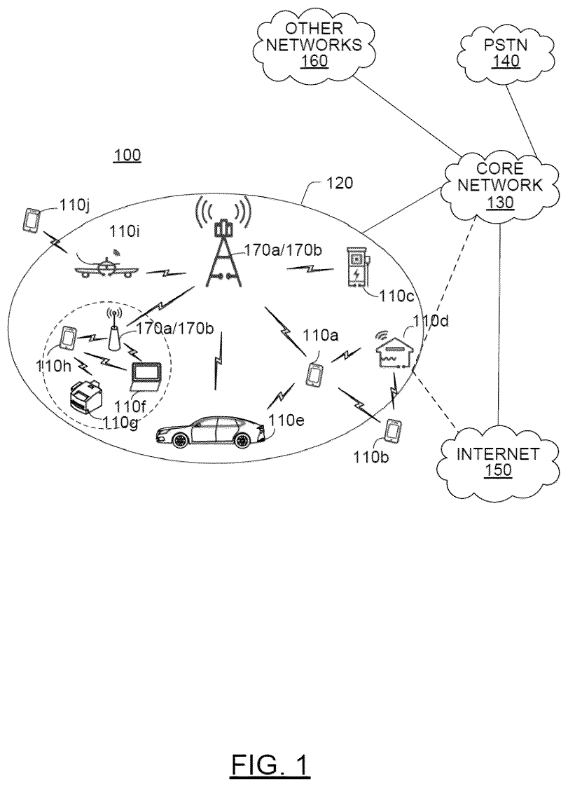

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

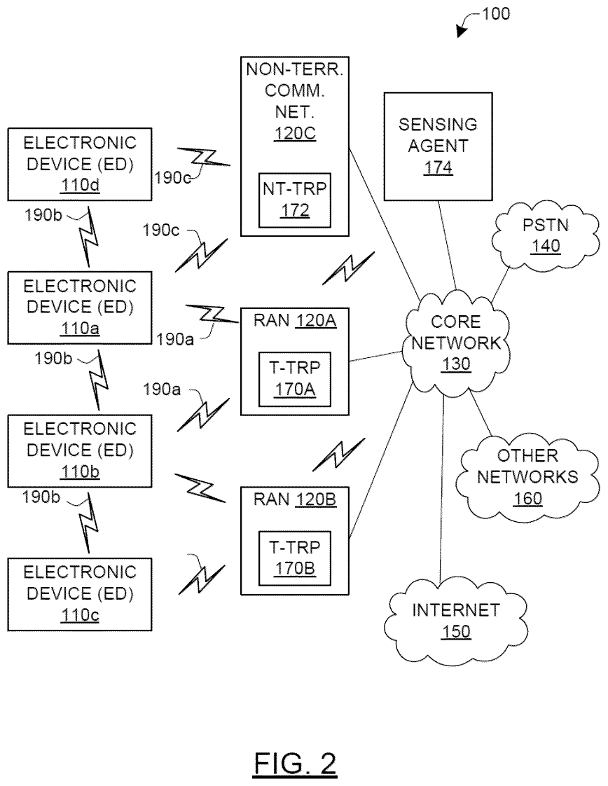

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

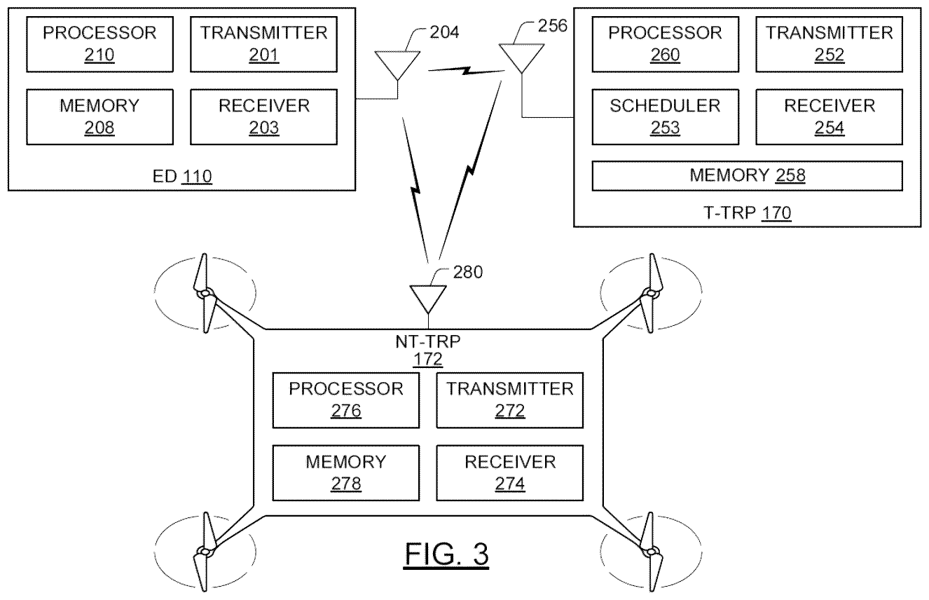

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read-only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

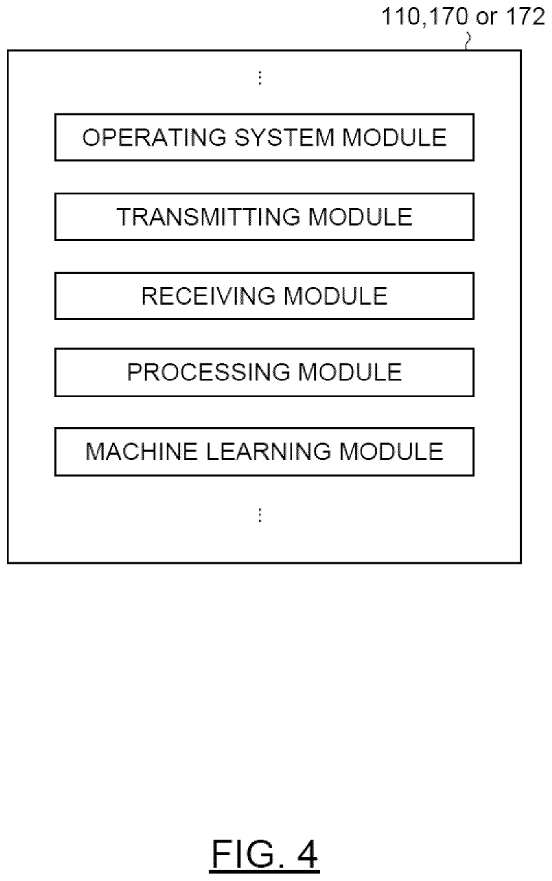

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

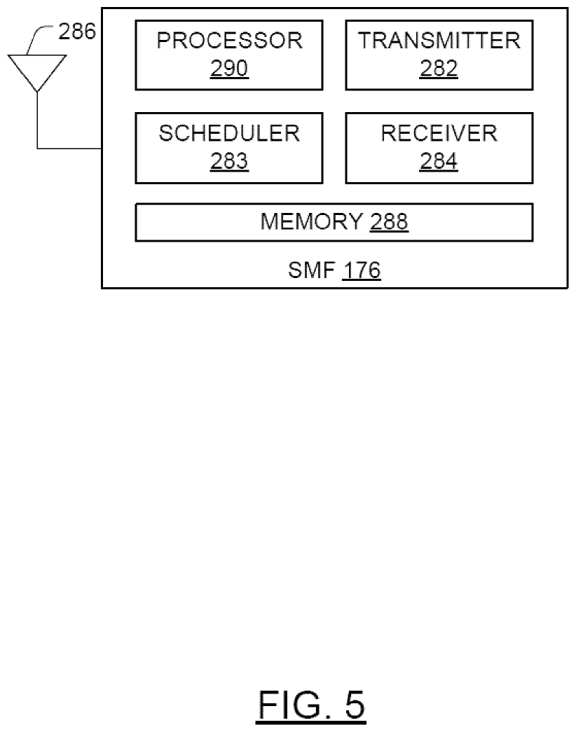

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp,” orthogonal frequency-division multiplexing (OFDM), cyclic prefix (CP)-OFDM and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f-f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp rate. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt2} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

In the past, wireless data communication systems have been studied, designed and developed independently from radar systems and other sensing systems. In contrast, it is expected that future wireless systems will integrate data communication systems with sensing systems. These future wireless systems may be known as integrated sensing and communication (ISAC) systems. In general, in an ISAC system, sensing is performed along with data communication. It may be shown that, in an ISAC system, at a UE, an estimate of a delay, a Doppler shift experienced by a signal received from a transmitter and an angle of arrival for the signal, may be used to estimate a distance between the transmitter and the receiver (known as a “range”) and a velocity for the UE. Such delay, angle and Doppler shift information may be shown to be useful in a variety of applications. Such delay, angle and Doppler shift information may be shown to help, through the use of sensing-assisted data communication, the quality of communication.

To enable both communication and sensing in ISAC systems, some network resources are allocated to communication and some network resources are allocated to sensing. It may be considered generally desirable to have an ISAC solution that is characterized by relatively high flexibility and relatively low complexity.

One known ISAC solution involves use of separate, also called “non-overlapped,” time-frequency resources for communication and sensing. Specifically, the resources allocated for communication and the resources allocated for sensing can be separated in time and/or in frequency. Such a non-overlapped time-frequency resource allocation provides a flexible design in some respects. For example, non-overlapped time-frequency resource allocation may be shown to enable the use of one waveform for sensing and a different waveform for communication. The use of different waveforms may allow for simultaneous satisfaction of communication objectives and satisfaction of sensing objectives. Furthermore, non-overlapped time-frequency resource allocation may be shown to eliminate any possible mutual interference between sensing and communication. However, non-overlapped time-frequency resource allocation may be shown to not be very efficient. Indeed, when the amount of resources is limited, the separated use of resources may be shown to lead to an insufficient amount of resources being available to satisfy one, or both, objectives. For example, the bandwidth available may be too low to satisfy sensing objectives or data communication objectives.

Another known ISAC solution, proposed in Liu, F., Cui, Y., Masouros, C., Xu, J., Han, T.X., Eldar, Y. C. and Buzzi, S., “Integrated sensing and communications: Towards dual-functional wireless networks for 6G and beyond,” arXiv preprint arXiv: 2108.07165 (hereinafter “the Liu paper”), involves using overlapped time-frequency resources for communication and sensing. In the context of the present application, a resource unit is a unit defined in a time-frequency domain. A resource unit may be assigned to data communication or to sensing. For one example, a resource unit may be a resource block known to be defined in various standards propagated by 3GPP (see www.3gpp.org). In this ISAC solution, all resource units in the time-frequency domain, or a part of the resource units in the time-frequency domain, are used for both communication and sensing. Consequently, the same waveform is used over the shared time-frequency resource units both for communication and for sensing. The Liu paper broadly discloses three general options or categories of ISAC.

A first option (option 1) may be considered to be a communication-centric design. The first option involves selecting a waveform that has good communication characteristics, such as an OFDM waveform, and then adding sensing functionalities to the selected waveform.

A second option (option 2) may be considered to be a sensing-centric design. The second option involves selecting a waveform used in radar. For instance, it is generally considered that a so-called chirp waveform has good correlation properties for sensing. The chirp waveform can be modified by embedding, into the selected waveform, data. It follows that the resulting waveform may be used both for communication and for sensing.

On one hand, the first option and the second option may be considered to be efficient in the sense that overlapped resources are used both for communication and for sensing. However, the first option and the second option may be considered to be inflexible since either a waveform suited for communication is used for sensing or a waveform suited for sensing is used for communication and it is known that sensing and communication have different objectives.

A third option (option 3) involves use of a fully integrated waveform design. The third option may be considered to be neither communication-centric nor sensing-centric. However, the proposed schemes in the literature for this option (see the Liu paper) may be considered to require heavy computations and optimizations. In such proposed schemes, design of a fully integrated ISAC waveform, with overlapped resources, is formulated as a complex optimization problem for which a solution needs to be determined online (i.e., in real-time) during system operation. A solution determined for such a complex optimization problem can be shown to achieve both communication objectives and sensing objectives through the use of a waveform jointly optimized for both communication and sensing. However, determining solutions for such complex optimization problems may be shown to incur a substantial complexity penalty.

Accordingly, it is desirable to have a low-complexity, flexible and efficient design for use of overlapped resources both for communication and for sensing.

In overview, aspects of the present application relate to the third option described hereinbefore but, advantageously, do not require complex optimization. Although aspects of the present application do not require complex optimization, aspects of the present application also do not preclude such optimizations. Accordingly, aspects of the present application may be shown to enable a degree of flexibility in the deployment of an ISAC system. Aspects of the present application involve use of two waveforms, one waveform for communication and one waveform for sensing. In general, aspects of the present application relate to the generation of the waveforms and the multiplexing of the waveforms in the power domain to, thereby, result in an integrated waveform. Conveniently, the integrated waveform may be shown to both achieve communication objectives and achieve sensing objectives.

Generally, when suitable and unless stated otherwise, the terms “waveform” and “signal” may be used interchangeably in the present application. For context, brief definitions of the terms “waveform” and “signal” and explanations for why the terms “waveform” and “signal” can be used interchangeably follow below.

The term “signal” may be used as a representation of what is actually transmitted through the channel. The term “waveform” may be used as a representation of a general form of that signal. Specifically, a given waveform may be described using a plurality of parameters. If a waveform is generated on the basis of the plurality of parameters, including inserting or setting data symbols in a data-carrying waveform, the expected result is the signal that is to be transmitted through the channel. Changing the plurality of parameters describing the waveform will lead to corresponding changes in the generated or transmitted signal. For most purposes, therefore, multiplexing (or superposition) of signals (e.g., communication signals and sensing signals) in the power domain may be considered to be equivalent to multiplexing of the signals' respective waveforms in the power domain. Since there is a very close relationship between a signal and a waveform, the terms are typically used interchangeably in the context of multiplexing.

Furthermore, a typical discussion of different waveforms implies that the different waveforms (and consequently the different signals generated from the different waveforms) are broadly dissimilar in their forms. Whereas, a typical discussion of different signals may not imply such differentiation; a reference to different signals may commonly refer to the same types or forms of signals, but just carrying different data. Therefore, the present application primarily refers to a multiplexing of waveforms, even though a detailed review of an implementation may actually reveal that signals are multiplexed.

Aspects of the present application focus on a downlink scenario including a TRP 170 and multiple UEs 110. Notably, aspects of the present application may also be applied in an uplink scenario, wherein one or multiple UEs 110 transmit a communication signal and/or a sensing signal to a TRP 170. Further notably, aspects of the present application may also be applied in a sidelink scenario, wherein one or multiple UEs 110 transmit a communication signal and/or a sensing signal to other UEs 110. Aspects of the present application revolve around three general ideas: allocating overlapped time-frequency resource units for communication and sensing; multiplexing a communication waveform and a sensing waveform in the power domain over the overlapped time-frequency resource units; and allocating most of the transmit power at the TRP 170 to the communication waveform over the overlapped time-frequency resource units to, thereby, maintain communication performance. To achieve an arguably good sensing performance, matched filtering, e.g., pulse compression may be relied upon at the sensing receiver. Matched filtering/Pulse compression may be shown to improve sensing signal-to-interference-and-noise ratio (SINR) despite low transmit power allocated to the sensing waveform. Aspects of the present application relate to stating with two waveforms: one waveform for communication and one waveform for sensing. These two waveforms can be selected from among existing waveforms that are known to be good for communication (e.g., an OFDM waveform) and from among existing waveforms that are known to be good for sensing (e.g., a chirp waveform). Aspects of the present application relate to multiplexing the two waveforms in the power domain to, thereby, create a combined and integrated waveform. The combined and integrated waveform may be used both for communication and for sensing. Therefore, in the end, there is only one waveform (the integrated waveform). The integrated waveform may be shown to both achieve communication objectives and achieve sensing objectives. The integrated waveform may be created through a power domain multiplexing of two base waveforms, one of the base waveforms is designed for communication and the other base waveform is designed for sensing.

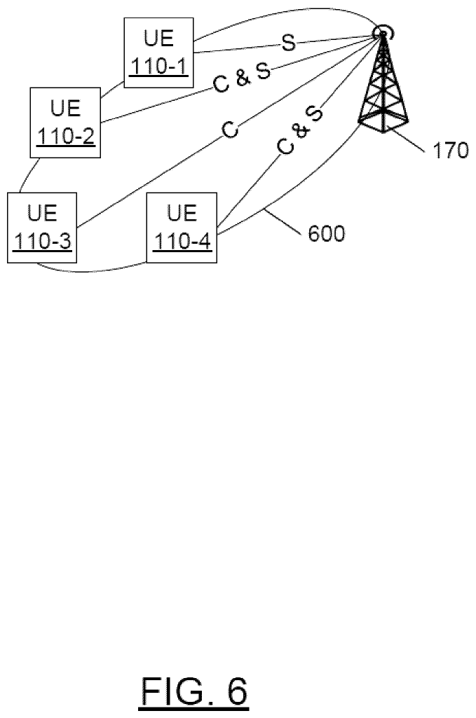

FIG. 6 illustrates an example environment wherein a TRP 170 transmits a spatial beam 600 that covers a first UE 110-1, a second UE 110-2, a third UE 110-3 and a fourth UE 110-4. In the moment represented by FIG. 6, the first UE 110-1 may be configured to only perform sensing, the second UE 110-2 and the fourth UE 110-4 may be configured to perform both communication and sensing and the third UE 110-3 may be configured to only receive data.

In an initial step, the TRP 170 may determine a manner in which to allocate time-frequency resource units between sensing and communication. It may be shown that, for enhanced efficiency, it is preferred to use overlapped resource units, so that, among a fixed set of resource units, both sensing and communication can use more resource units. However, it may be shown that there are various challenges associated with the use of overlapped resource units. The challenges include avoiding a mutual interference between sensing and communication. Aspects of the present application may be shown to provide a relatively low-complexity approach to the use of overlapped resource units for communication and sensing. After allocating resources to communication and sensing, the TRP 170 may allocate the resource units among the UEs 110.

For example, the first UE 110-1 of FIG. 6 may be assigned some resource units from among the resource units that have been allocated to sensing. Also, the second UE 110-2 may be assigned resource units from among the resource units that have been allocated to both sensing and communication. The TRP 170 may then generate, from a communication-specific waveform, a signal for transmitting, in the resource units allocated to communication, communication data destined for the UEs 110. The TRP 170 may also generate, from a sensing-specific waveform (e.g., a chirp waveform), a signal made up of sequences for transmitting, in the resource units allocated to sensing. In aspects of the present application, sequences known to be good for sensing detection may be used by the TRP 170. The TRP 170 may then superimpose the two signals in the power domain.

A pair of indices, (t, r), may be used to represent a particular time-frequency resource unit, where the first index, t, exists in the time domain and the second index, r, exists in the frequency domain. In view of the pair of indices, (t, r), the superimposition of the two signals, in the baseband digital domain, may be defined in an equation as:

$$x ( t , r ) = \sqrt{{p}_{s} ( t , r )} {x}_{s} ( t , r ) + \sqrt{{p}_{c} ( t , r )} {x}_{c} ( t , r )$$

where x(t, r) is representative of the superimposed waveform (or signal), xₛ(t, r) is representative of a sensing waveform (or signal), pₛ(t,r) is representative of a transmit power assigned to the sensing waveform (or signal), x_{c}(t, r) is representative of a communication waveform (or signal) and p_{c}(t,r) is representative of a transmit power assigned to the communication waveform (or signal). Notably, if the time-frequency resource unit represented by the pair of indices, (t, r), is only allocated to communication, then pₛ(t, r)=0. Similarly, if the time-frequency resource unit represented by the pair of indices, (t, r), is only allocated to sensing, then p_{c}(t,r)=0. If the time-frequency resource unit represented by the pair of indices, (t, r), is to be shared, then the transmit power, pₛ(t, r), assigned to the sensing waveform (or signal) and the transmit power, p_{c}(t, r), assigned to the communication waveform (or signal) are non-zero.

To maintain acceptable communication performance, the transmit power, p_{c}(t, r), assigned to the communication waveform (or signal) should be much larger than the transmit power, pₛ(t, r), assigned to the sensing waveform (or signal). It may be shown that communication SINR is proportional the transmit power, p_{c}(t, r), assigned to the communication waveform (or signal). The transmit power, p_{c}(t, r) assigned to the communication waveform (or signal) should be relatively large to, thereby, allow for high data rates. However, a relatively large transmit power, p_{c}(t, r), assigned to the communication waveform (or signal) may be shown to translates to a relatively small transmit power, pₛ(t, r), assigned to the sensing waveform (or signal), since a power budget available at the TRP 170 may be limited.

Pulse compression may be employed to mitigate a loss of sensing performance that may be expected to result from a diminished transmit power, pₛ(t,r), assigned to the sensing waveform (or signal). Pulse compression may be considered to rely upon a receiver of the sensing waveform (or signal) being configured to expect a particular sensing sequence. Pulse compression is a signal processing technique in which a long pulse is modulated at a transmitter. A matched filter or a correlator may then be used at a receiver, leading to a higher estimation resolution and a higher SINR than would be possible without the matched filter or correlator. It follows that, in principle, the use of pulse compression to process a received sensing waveform (or signal) may lead to a relatively large processing gain. The processing gain may be expressed as N=BT, where B is representative of the bandwidth of the sensing signal and T is representative of sensing symbol time duration. Notably, N may be interpreted as a total number of degrees of freedom in the system. In OFDM systems, the number of degrees of freedom in the system is equal to the product of the number of subcarriers and the number of OFDM symbols. It follows that a post-processing sensing SINR is N times a pre-processing SINR. Accordingly, even if the pre-processing SINR is low, due to having a low transmit power, pₛ(t,r), assigned to the sensing waveform (or signal), the processing gain can compensate.

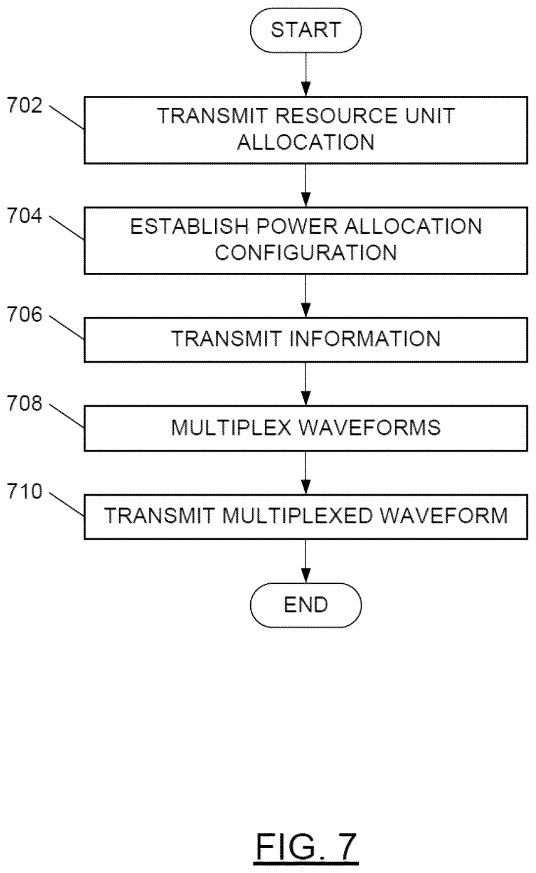

FIG. 7 illustrates example steps in a method of power domain multiplexing of communication waveforms (signals) and sensing waveforms (signals). Initially, the TRP 170 transmits (step 702), to the UEs 110, an indication of time-frequency resource unit allocation. The indication may reference a plurality of time-frequency resource units and allocate, to one or more of the time-frequency resource units, one of communication, sensing or both communication and sensing. On the level of a particular time-frequency resource unit, the TRP 170 may transmit (step 702), to a UE 110, an indication that the particular time-frequency resource unit, among the plurality of time-frequency resource units, has been allocated to both sensing and communication.

There are various ways to define time-frequency resource allocation information to be transmitted (step 702) to the UEs 110.

A first way to define time-frequency resource allocation information to be shared by the UEs 110 involves defining the time-frequency resource allocation information such that the time-frequency resource allocation information includes, for each UE 110, a reference to the time-frequency resource units allocated to communication and sensing. Notably, in general, there is no constraint on the sensing resource units to only be a part of communication resources for any UE 110.

A second way to define time-frequency resource allocation information to be shared by the UEs 110 involves defining time-frequency resource allocation information to include a set of resource units that are only allocated to communication, a set of resource units that are only allocated to sensing and a set of shared resource units (resource units that are allocated to both sensing and communication).

A third way to define time-frequency resource allocation information to be shared by the UEs 110 involves combining the first way and the second way.

The time-frequency resource allocation information can be transmitted (step 702) as a part of Downlink Control Information (DCI), or a combination of DCI and higher layer signaling, such as Radio Resource Control (RRC) signaling.

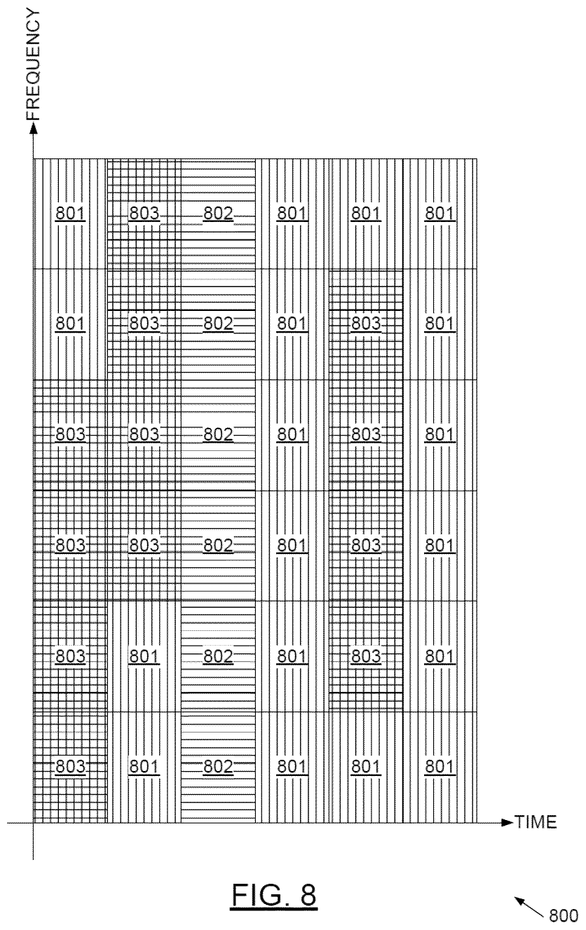

Notably, the time-frequency resource allocation may be carried out at the TRP 170. The time-frequency resource allocation may also be carried out at the core network 130. The results may then be provided, by the core network 130, to the TRP 170 by signaling. FIG. 8 illustrates an example representation 800 of time-frequency resource allocation information. The example representation 800 has time-frequency resource units laid out on a grid with time on the x-axis and frequency on the y-axis. After the time-frequency resource allocation has been carried out, some time-frequency resource units 801, among the overall set of time-frequency resource units, may be seen to have been allocated to communication. Some time-frequency resource units 802, among the overall set of time-frequency resource units, may be seen to have been allocated to sensing. According to aspects of the present application, the set of resource units allocated to sensing and the set of resource units allocated to communication can have overlap, i.e., some time-frequency resource units 803, among the overall set of resource units may be seen to have been allocated to both communication and sensing.

As a result, there are three types of time-frequency resource units. There are time-frequency resource units 801 of a first type, identified as being allocated to communication only. There are time-frequency resource units 802 of a second type, identified as being allocated to sensing only. There are time-frequency resource units 803 of a third type, identified as being allocated to both communication and sensing.

Notably, there is no need for waveform multiplexing for time-frequency resource units 801 of the first type or time-frequency resource units 802 of the second type. Aspects of the present application relate to using power domain multiplexing of communication and sensing waveforms in the time-frequency resource units 803 of the third type.

In a time-frequency resource allocation process, the available sensing and communications resource units 801/802/803 are distributed among the UEs 110. There are at least three characterization possibilities for each UE.

A UE 110 may be characterized as a “sensing-only UE” 110-1 (see FIG. 6). The sensing-only UE 110-1 may be configured to only perform sensing. The sensing-only UE 110-1 may be expected to be capable of performing sensing detection and estimation.

A UE 110 may be characterized as a “communication-only UE” 110-3 (see FIG. 6). The communication-only UE 110-3 may be configured to receive data from the TRP 170. The communication-only UE 110-3 may be expected to be capable of performing communication functionalities. Notably, the communication-only UE 110-3 may be configured only for decoding communication data from a received waveform (signal). The communication-only UE 110=3 may also be capable of performing sensing. However, the communication-only UE 110-3 may not be expected to perform sensing unless the communication-only UE 110-3 is to obtain some channel parameters for use while decoding the communication data from a received waveform (signal).

A UE 110 may be characterized as an “ISAC UE” 110-2/110-4 (see FIG. 6). The ISAC UE 110-2/110-4 may be configured to receive data and also to perform sensing. The ISAC UE 110-2/110-4 may be expected to have capabilities to perform both functionalities.

The communication-only UE 110-3 may be expected to be assigned a portion of the time-frequency resource units 801 that have been allocated to communication (the first type) or a portion of the time-frequency resource units 803 that have been allocated to both communication and sensing (the third type).

The sensing-only UE 110-1 may be expected to be assigned the time-frequency resource units 802 that have been allocated to sensing (the second type) or a portion of the time-frequency resource units 803 that have been allocated to both communication and sensing (the third type).

The ISAC UE 110-2/110-4 may be expected to be assigned a portion of the time-frequency resource units 801 that have been allocated to communication (the first type), a portion of the time-frequency resource units 802 that have been allocated to sensing (the second type) or a portion of the time-frequency resource units 803 that have been allocated to both communication and sensing (the third type). Notably, the time-frequency resource units 803 of the third type that have been allocated to the ISAC UE 110-2/110-4 can be fully overlapped or partially overlapped.

It may be shown that transmitting (step 702) the time-frequency resource allocation information, thereby informing the UEs 110 about allocation of specific time-frequency resource units 801/802/803 to the UEs 110, helps the UEs 110 to properly perform communication functionalities and sensing functionalities. The transmitting (step 702) the time-frequency resource allocation information may be accomplished through DCI as well as through higher-layer signaling, such as RRC and MAC control element (MAC-CE).

In view of FIG. 7, the TRP 170 next establishes (step 704) a power allocation configuration that allocates transmit power between sensing waveforms and communication waveforms for each of the time-frequency resource units 801/802/803. The TRP 170 may then transmit (step 706), to the UEs 110, information. The information transmitted in step 706 may include the power allocation configuration. The information transmitted in step 706 may additionally or alternatively include a sensing signal configuration. The transmitting (step 706) of the information may be carried out through control signaling.

The TRP 170 may then multiplex (step 708), in the power domain, a sensing waveform and a communication waveform to, thereby, generate a multiplexed waveform. In accordance with aspects of the present application, the multiplexing (step 708) is carried out in a manner that corresponds to the power allocation configuration established in step 704. The TRP 170 may then transmit (step 710) the multiplexed waveform.

At the UE 110, the power allocation configuration, that is, the information transmitted in step 706, may be useful when the UE 110 is cancelling a sensing waveform (signal) from a received waveform (signal), as will be explained hereinafter.

Furthermore, it may be considered to be beneficial for the communication-only UE 110-3 to receive the power allocation configuration, which may be transmitted in step 706.

The communication-only UE 110-3 may use a cancellation approach used by the ISAC UE 110-2/110-4, in which the power allocation configuration is useful.

The communication-only UE 110-3 may use another approach, explained in more detail hereinafter, in which the power allocation configuration is useful for determining a SINR. Notably, the determined SINR may be used when decoding the communication waveform (signal). It follows, then, that transmitting (step 704), to the ISAC UEs 110-2/110-4 and the communication-only UE 110-3, information including the power allocation configuration, over the resource units assigned to the ISAC UEs 110-2/110-4 and the communication-only UE 110-3. Such UE-specific information can be conveyed through DCI and/or higher-layer UE-specific signaling, such as at least one of RRC and MAC-CE.

Furthermore, the sensing configuration (e.g., a sensing waveform type and various sensing waveform parameters) may be used at UEs 110 in a manner that will be discussed hereinafter. The transmission (step 706), to the UEs 110, of the sensing configuration may be carried out using control signaling. One approach for designing a sensing waveform is to use a known sequence with good correlation properties. Good correlation properties are known to be important to sensing performance. A sequence may be described by one parameter or by multiple parameters. In this case, the TRP 170 may use by UE-specific control signaling to transmit (step 706) the parameter(s) describing the sensing waveform. For instance, a chirp signal (which may also be known as a “linear frequency modulated signal”) is known to have good characteristics to be used for sensing applications. Chirp signals are known to have low correlation side-lobe levels and be mostly tolerant to Doppler frequency shifts. Chirp signals are known to be characterized by a parameter called a chirp rate. If a chirp signal is used as a sensing waveform, the TRP 170 may transmit (step 706) the chirp rate (or chirp rates, in the case of a plurality of chirp signals) to the corresponding UEs 110 using control signaling.

The ISAC UE 110-2/110-4 and the sensing-only UE 110-1 may make use of the sensing configuration when the sensing configuration is used in a sensing receiver algorithm, which will be described hereinafter.

It makes sense, then, for the TRP 170 to transmit (step 706), to the ISAC UEs 110-2/110-4 and the sensing-only UE 110-1, the sensing configuration.

Furthermore, the TRP 170 may transmit (step 706) the sensing configuration to the communication-only UE 110-3. As will be described hereinafter, if the communication waveform (signal), transmitted by the TRP 170 in the time-frequency resource units 801 allocated to the communication-only UE 110-3, does not include a pilot signal for channel estimation, then the communication-only UE 110-3 may perform sensing to obtain an estimate of the channel. The estimate of the channel may be seen as useful for decoding the communication waveform. The TRP 170 may use signaling to transmit (step 706) the sensing configuration to the communication-only UE 110-3.

Notably, the communication waveform (signal), transmitted by the TRP 170 in the time-frequency resource units 801 allocated to the communication-only UE 110-3, may include a pilot signal for channel estimation. Notably, in the pilot-present scenario, the communication-only UE 110-3 may still use receipt of the sensing configuration to improve communication performance. For example, as will be explained hereinafter, the communication-only UE 110-3 may improve communication performance by cancelling the sensing waveform (signal) in the time-frequency resource units 803 in which both the communication waveforms and the sensing waveform are present.

A general implementation of power-domain multiplexing may be accomplished using one of at least two approaches. In one approach, power-domain multiplexing may be implemented using multiplexing in the RF domain. In another approach, power-domain multiplexing may be implemented using multiplexing in the baseband domain.

Using the communication waveform, a baseband communication signal may be generated from communication symbols and, on the basis of the baseband communication signal, an RF domain communication signal, x_{RF,com}(t), may be constructed. Similarly, using the sensing waveform, a baseband sensing signal may be generated and, on the basis of the baseband sensing signal, an RF domain sensing signal, x_{RF,sen}(t), may be constructed. Alternatively, a RF domain sensing signal, x_{RF,sen}(t), may be directly generated in the RF domain.

An RF domain communication and sensing signal may be obtained by multiplexing, in the power domain, the RF domain communication signal and the RF domain sensing signal according to a given power allocation, as follows:

$${x}_{RF , Int} ( t ) = \sqrt{{p}_{c}} {x}_{RF , com} ( t ) + \sqrt{{p}_{s}} {x}_{RF , sen} ( t ) .$$

The terminology “multiplexing, in the power domain” may be interpreted as an adding together with appropriate power coefficients.

Upon obtaining the RF domain communication and sensing signal, the RF domain communication and sensing signal may be subjected to standard RF domain procedures and then transmitted.

Using the communication waveform, a baseband communication signal may be generated from communication symbols.

Using the sensing waveform, a baseband sensing signal may be generated.

A baseband domain communication and sensing signal may be obtained by multiplexing, in the power domain, the baseband domain communication signal and the baseband domain sensing signal according to a given power allocation.

A RF domain communication and sensing signal may then be obtained by converting the baseband domain communication and sensing signal to the RF domain. Upon obtaining the RF domain communication and sensing signal, the RF domain communication and sensing signal may be subjected to standard RF domain procedures and then transmitted.

Aspects of the present application relate to receiver architecture and procedures for an ISAC UE (such as, for example, the second UE 110-2 illustrated in FIG. 6) in the context of the power domain waveform multiplexing scheme proposed herein. An ISAC UE may be considered to be a UE configured to receive data and to perform sensing. Additionally, an ISAC UE may be considered to have capabilities to perform communication and to perform sensing.

As discussed hereinbefore, a multiplexed waveform, x, is transmitted by the TRP 170. The transmitted multiplexed waveform, x, may be understood to include sensing waveforms and communication waveforms destined for each of the four UEs 110-1, 110-2, 110-3, 110-4 in FIG. 6. The transmitted multiplexed waveform, x, may be understood to be transmitted with the spatial beam 600 illustrated in FIG. 6. Communication data symbols destined for different UEs (e.g., the ISAC UEs 110-2, 110-4 and the communication-only UE 110-3) may be multiplexed in time-frequency domain. Similarly, sensing signals destined for different UEs (e.g., the ISAC UEs 110-2, 110-4 and the sensing-only UE 110-1) may be multiplexed in the time-frequency domain. However, the time-frequency resources used for sensing and communication can overlap, as explained hereinbefore. In the overlapped time-frequency resources, the communication and sensing signals are multiplexed in the power domain. The transmitted multiplexed waveform, x, may be understood to include components, x₁, x₂, x₃, x₄, each destined for a corresponding one of the four UEs 110-1, 110-2, 110-3, 110-4. Furthermore, the channel between the TRP 170 and each of the four UEs 110-1, 110-2, 110-3, 110-4 is distinct, such that the received multiplexed waveform that arrives at each of the four UEs 110-1, 110-2, 110-3, 110-4 is expected to be altered in a distinct manner. For example, a received multiplexed waveform, y₂, that is received at the second UE 110-2 is expected to be distinct from a received multiplexed waveform, y₃, that is received at the third UE 110-3.

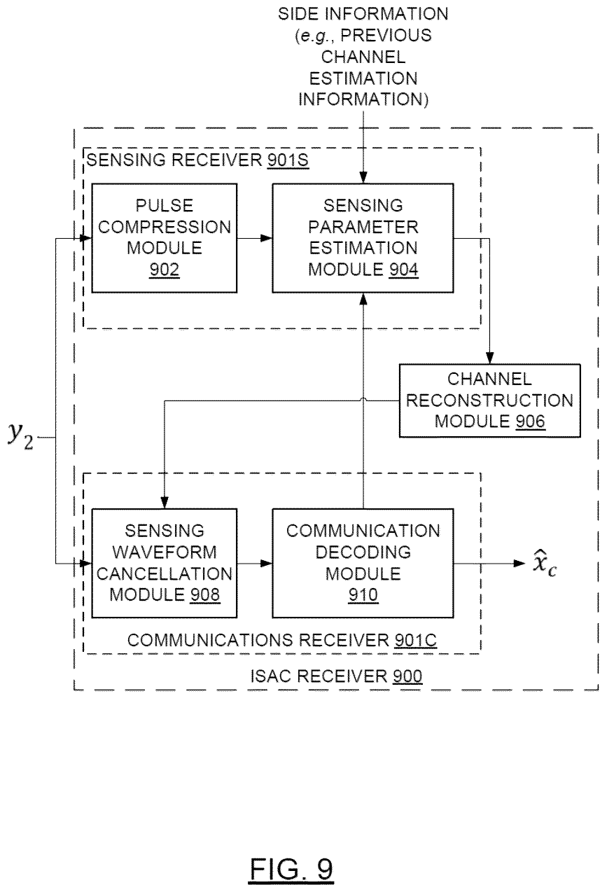

FIG. 9 illustrates, as a block diagram, an example structure for a receiver 900 suitable for the ISAC UEs 110-2/110-4. It may be understood that the TRP 170 (see FIG. 6) has data to communicate to the second UE 110-2. The TRP 170 encodes the data in a communication waveform. The TRP 170 multiplexes (step 708, FIG. 7) the communication waveform into a multiplexed waveform, x₂. The TRP 170 then transmits (step 710, FIG. 7) the multiplexed waveform, x₂. One goal of the receiver 900 is to obtain a decoded version of the data that was encoded at the TRP 170.

The receiver 900 of FIG. 9 includes a sensing receiver 901S, a communication receiver 901C and a channel reconstruction module 906. The sensing receiver 901S includes a pulse compression module 902 and a sensing parameter estimation module 904. The communication receiver 901C includes a sensing waveform cancellation module 908 and a communication decoding module 910.

There are several general procedures that may be expected to be performed at an ISAC UE. One of the general procedures relates to receiving time-frequency resource allocation information (see FIG. 8) from a TRP 170. Another one of the general procedures relates to receiving the power allocation configuration and/or the sensing waveform configuration from the TRP 170. A further one of the general procedures relates to receiving the multiplexed waveform from the TRP 170. An even further one of the general procedures relates to de-multiplexing, from the received multiplexed waveform, the sensing waveform and the communication waveform in the power domain.

It is expected that the channel over which the signal from the TRP 170 travels to arrive at the receiver 900 of FIG. 9 changes the transmitted multiplexed waveform, x₂, to a received multiplexed waveform, y₂. In view of FIG. 9, the pulse compression module 902 is configured to de-multiplex, from the received multiplexed waveform, y₂, the sensing waveform. Similarly, the sensing waveform cancellation module 908 is configured to de-multiplex, from the received multiplexed waveform, y₂, the communication waveform.

A still further one of the general procedures relates to processing the separate waveforms. At the sensing parameter estimation module 904, the sensing waveform is processed to obtain an estimate of sensing parameters (such as delay, angle and Doppler shift). At the channel reconstruction module 906, the estimate of the sensing parameters may be used to obtain a channel estimate. The channel estimate, obtained by the channel reconstruction module 906 may be used by the sensing waveform cancellation module 908, in combination with a priori information about the sensing waveform, when cancelling, from the received multiplexed waveform, y₂, the sensing waveform. At the communication decoding module 910, the communication waveform is processed to obtain a decoded version of the data that was encoded at the TRP 170.

Aspects of the present application relate to receiver architecture and procedures for a communication-only UE (such as, for example, the third UE 110-3 illustrated in FIG. 6) in the context of the power domain waveform multiplexing scheme proposed herein. A communication-only UE may be considered to be a UE configured to receive data from the TRP 170. Additionally, a communication-only UE may be considered to have capabilities to perform communication. Note that a communication-only UE is only configured to decode communication data from a received waveform. Such a communication-only UE may also be capable of performing sensing but a communication-only UE would not be expected to perform sensing unless sensing is to be employed to obtain some channel parameters that may be useful for the communication decoding.

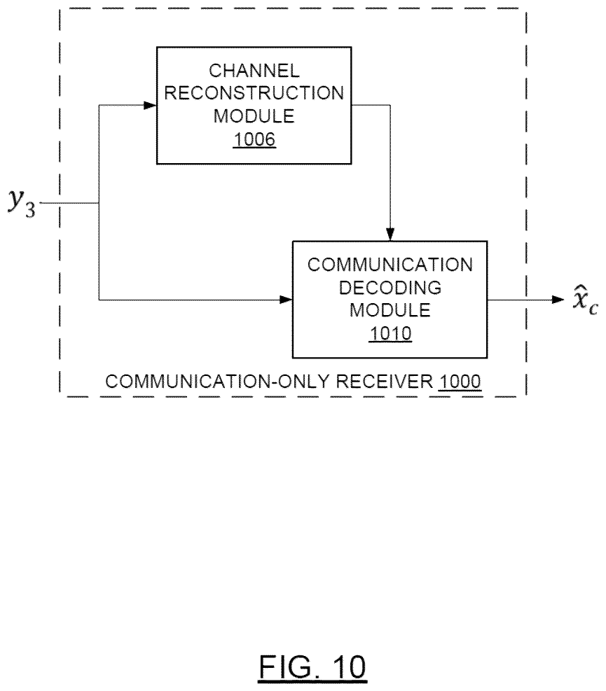

FIG. 10 illustrates, as a block diagram, an example structure for a receiver 1000 suitable for the communication-only UE 110-3. It may be understood that the TRP 170 (see FIG. 6) has data to communicate to the third UE 110-3. The TRP 170 encodes the data in a communication waveform, x₃. As illustrated in FIG. 10, the receiver 1000 for the communication-only UE 110-3 includes a channel reconstruction module 1006 and a communication decoding module 1010.

There are several general procedures that may be expected to be performed at a communication-only UE. One of the general procedures relates to receiving time-frequency resource allocation information (see FIG. 8) from a TRP 170. Another one of the general procedures relates to receiving the power allocation configuration and/or the sensing waveform configuration from the TRP 170. A further one of the general procedures relates to receiving a waveform from the TRP 170. An even further one of the general procedures relates to, if necessary, de-multiplexing, from the received waveform, the sensing waveform and the communication waveform in the power domain.

A still further one of the general procedures relates to processing the communication waveform to obtain a decoded version of the data that was encoded at the TRP 170.

In aspects of the present application, the so-called communication-only UE 110-3 may be configured to have a priori information regarding whether or not the waveform transmitted, by the TRP 170, to the communication-only UE 110-3 will include a sensing waveform, xₛ. In aspects of the present application, the so-called communication-only UE 110-3 may be configured to have a priori information regarding whether or not there is pilot for channel estimation included in the communication waveform, x_{c}. Notably, it is known to include a pilot in a communication waveform. If there is a pilot included in a communication waveform, the communication waveform may be referenced as “pilot enabled.” Both types of a priori information may be provided to the communication-only UE 110-3 by signaling. Note that the a priori information regarding whether or not a sensing waveform is included in the transmitted waveform may be implied, by the communication-only UE 110-3, from the time-frequency resource allocation (see FIG. 8) shared by the TRP 170 as described hereinbefore.

It is expected that the channel over which the signal from the TRP 170 travels to arrive at the receiver 1000 of FIG. 10 changes the transmitted waveform, x₃, to a received waveform, y₃. Consider that the communication-only UE 110-3 has the a priori information that a sensing waveform is not included in the transmitted waveform and that the communication waveform is pilot enabled. In aspects of the present application, the channel reconstruction module 1006 receives the communication waveform, y₃, and uses the pilot to obtain a channel estimate. The channel reconstruction module 1006 transmits the channel estimate to the communication decoding module 1010. The communication decoding module 1010 receives the communication waveform, y₃, and the channel estimate. The communication decoding module 1010 uses the channel estimate when decoding the communication waveform, y₃, to obtain a decoded version of the data that was encoded at the TRP 170.

Consider that the communication-only UE 110-3 has the a priori information that a sensing waveform is included in the transmitted waveform and that the communication waveform is not pilot enabled. In aspects of the present application, the communication-only UE 110-3 may employ a receiver with the architecture 900 illustrated in FIG. 9. In the absence of a pilot, the communication-only UE 110-3 may not be reasonably expected to obtain a channel estimate.

The communication-only UE 110-3 may, in this case, receive a multiplexed waveform, y₂. The pulse compression module 902 is configured to de-multiplex, from the received multiplexed waveform, y₂, the sensing waveform. At the sensing parameter estimation module 904, the sensing waveform is processed to obtain an estimate of sensing parameters (such as delay, angle and Doppler shift). At the channel reconstruction module 906, the estimate of the sensing parameters may be used to obtain a channel estimate. The channel estimate, obtained by the channel reconstruction module 906 may be used by the sensing waveform cancellation module 908, in combination with a priori information about the sensing waveform, when cancelling, from the received multiplexed waveform, y₂, the sensing waveform. The sensing waveform cancellation module 908 may then de-multiplex, from the received multiplexed waveform, y₂, the communication waveform. At the communication decoding module 910, the communication waveform is processed to obtain a decoded version of the data that was encoded at the TRP 170 using the channel estimation that has already been obtained by sensing.

Consider that the communication-only UE 110-3 has the a priori information that a sensing waveform is included in the transmitted waveform and that the communication waveform is pilot enabled. In this situation there are three cases to consider.

In a first case, the communication-only UE 110-3 may employ a receiver with the architecture 900 illustrated in FIG. 9. The communication-only UE 110-3 may, in the first case, receive a multiplexed waveform, y₂. The pulse compression module 902 may de-multiplex, from the received multiplexed waveform, y₂, the sensing waveform. The sensing parameter estimation module 904 may process the sensing waveform to obtain an estimate of sensing parameters (such as delay, angle and Doppler shift). The channel reconstruction module 906 may use the estimate of the sensing parameters to obtain a channel estimate. The sensing waveform cancellation module 908 may use channel estimate when cancelling, from the received multiplexed waveform, y₂, the sensing waveform. The sensing waveform cancellation module 908 may then de-multiplex, from the received multiplexed waveform, y₂, the communication waveform. The communication decoding module 910 may process the communication waveform to obtain a decoded version of the data that was encoded at the TRP 170.

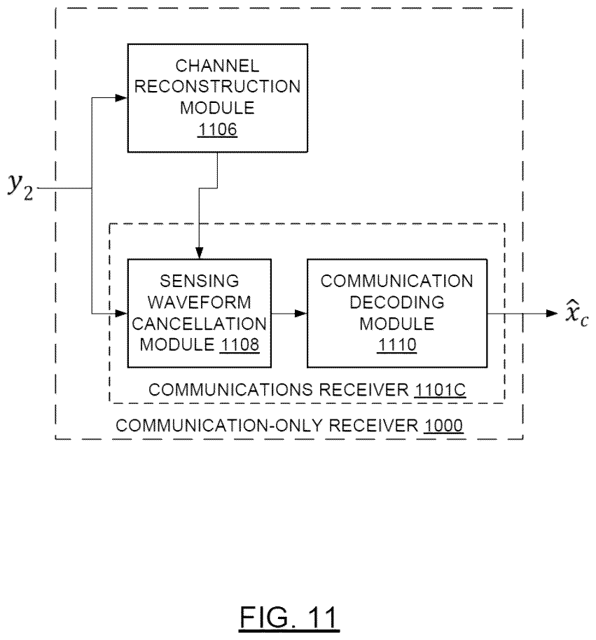

In a second case, the communication-only UE 110-3 may ignore the sensing waveform part of a received multiplexed waveform. The second case may be considered to be an adaptation of a legacy approach in the context of the power domain waveform multiplexing scheme proposed herein. For the second case, the communication-only UE 110-3 may employ a receiver architecture 1100 illustrated in FIG. 11.

The receiver 1100 of FIG. 11 includes a communication receiver 1101C and a channel reconstruction module 1106. The communication receiver 1101C includes a sensing waveform cancellation module 1108 and a communication decoding module 1110.

Upon receiving the multiplexed waveform, y₂, a channel reconstruction module 1106 may use the pilot in the communication waveform when obtaining a channel estimate. Under an assumption that the communication-only UE 110-3 has a priori information about the sensing waveform, the channel estimate, obtained by the channel reconstruction module 1106 may be used by the sensing waveform cancellation module 1108, in combination with the a priori information about the sensing waveform, when cancelling, from the received multiplexed waveform, y₂, the sensing waveform. The sensing waveform cancellation module 1108 may then de-multiplex, from the received multiplexed waveform, y₂, the communication waveform. The communication decoding module 1110 may process the communication waveform to obtain a decoded version of the data that was encoded at the TRP 170.

In this second case, the communication-only UE 110-3 is expected to have the a priori information about the sensing configuration and information about the power allocation. This information may be provided, to the communication-only UE 110-3, via signaling. Notably, the receiver architecture 1100 illustrated in FIG. 11 is distinct from the receiver architecture 900 illustrated in FIG. 9 in that the receiver architecture 1100 illustrated in FIG. 11 lacks the sensing receiver 901S that is present in the receiver architecture 900 illustrated in FIG. 9. Notably, it is expected that the communication-only UE 110-3 has received information about the power allocation between the communication waveform and the sensing waveform. The power allocation may be shown to assist the sensing waveform cancellation module 1108 when cancelling, from the received multiplexed waveform, y₂, the sensing waveform.

If the communication-only UE 110-3 does not cancel the sensing waveform for any reason, such as not having the a priori information about the sensing configuration, the communication-only UE 110-3 may consider the sensing waveform as interference.

The information about the power allocation between the communication waveform and the sensing waveform may be shown to assist the communication-only UE 110-3 when determining SINR. Notably, the determined SINR may be used when decoding the communication waveform. The information about the power allocation may be transmitted, to the communication-only UE 110-3, through signaling. Notably, in situations wherein the communication-only UE 110-3 considers the sensing waveform as interference, the power in the interference is unlikely to be considered large, since the power allocated to sensing is typically small relative to the power allocated to communication.

Aspects of the present application relate to construction of a communication waveform, x_{c}, in a manner that may lead a receiver to come to useful conclusions. The communication waveform, x_{c}, may be split into a shared part, a private part and a reference part.

The shared part (denoted by xₛₕ) may include control signals transmitted through control channels that are intended for all the UEs 110 or a group of UEs 110. Examples of control channels include a broadcast control channel (BCCH), a paging control channel (PCCH), a downlink shared channel (DL-SCH) and a common control channel (CCCH). The data rate of the shared part is typically low. The private part (denoted by xₚᵣ) may include data of the UEs 110. The reference part (denoted by x_{rf}) may include reference signals, such as demodulation reference signals, phase tracking reference signals and CSI-RS. The communication waveform, x_{c}, may be defined in an equation as:

$${x}_{c} = \sqrt{{p}_{sh}} {x}_{sh} + \sqrt{{p}_{pr}} {x}_{pr} + \sqrt{{p}_{rf}} {x}_{rf}$$

where pₛₕ is representative of a transmit power assigned to the shared part, pₚᵣ is representative of a transmit power assigned to the private part and p_{rf} is representative of a transmit power assigned to the reference part. Notably, the reference part need not necessarily be present in the communication waveform, x_{c}, since, in situation wherein a sensing waveform is multiplexed with the communication waveform, the receiver may be able to estimate channel parameters based on a processing of the received sensing waveform.

An ISAC UE 110-2/110-4 or a communication UE 110-3 may only be configured to receive a communication waveform, x_{c}, that includes a shared part or both a shared part and a private part. The shared part may be used by all UEs 110 or a group of UEs 110 to improve the sensing performance. Indeed, the shared part of the communication waveform, x_{c}, may be decoded and cancelled before the private part is decoded. Upon decoding the shared part, the shared part may be used as a part of the sensing waveform to improve the sensing estimation. In a similar fashion, the private part of the communication waveform, x_{c}, may be used to improve the sensing performance.

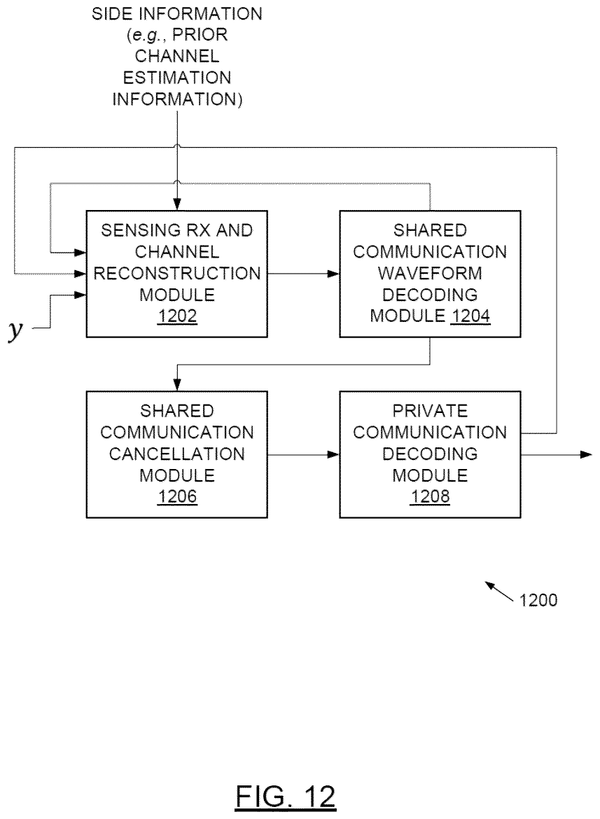

FIG. 12 illustrates, in a block diagram, an arrangement 1200 of modules for receiving a communication waveform with multiple parts, as described hereinbefore. The arrangement 1200 includes a sensing receiver and channel reconstruction module 1202, a shared communication waveform decoding module 1204, a shared communication cancellation module 1206 and a private communication decoding module 1208.

The arrangement 1200 of FIG. 12 may be considered to present a manner in which a shared part (if present in a communication waveform, x_{c}) and a private part (if present in the communication waveform, x_{c}) may be employed to improve sensing performance.

A received waveform, y, may be processed first by the sensing receiver and channel reconstruction module 1202. The sensing receiver and channel reconstruction module 1202 may include components illustrated in FIG. 9, include a sensing receiver similar to the sensing receiver 901S and a channel reconstruction module similar to the channel reconstruction module 906. Output from the sensing receiver and channel reconstruction module 1202 may be shown to allow the shared communication waveform decoding module 1204 to decode, from a communication waveform portion, x_{c}, of the received waveform, y, a shared part, xₛₕ. Output from the shared communication waveform decoding module 1204 may be shown to allow the shared communication cancellation module 1206 to remove the shared part, xₛₕ, from the communication waveform, x_{c}. Output from the shared communication waveform decoding module 1204 may also be fed back to the sensing receiver and channel reconstruction module 1202.

Notably, a reference part (if present in communication waveform, x_{c}) may also be employed to improve sensing performance in a similar manner, even though a reference part is not illustrated in FIG. 12. Further notably, there is no need to decode the reference part, since reference signals employ known sequences. Such communication reference signals may be counted as side information input to the sensing receiver and channel reconstruction module 1202 in FIG. 12.

Aspects of the present application relate to a case wherein the shared part of the communication waveform is removed and sensing waveform is used to play the role of the shared part of the communication waveform. Note that, while the shared part of the communication waveform is removed, there remains, at the TRP 170, an intention to transmit shared communication information (or data) to the UEs 110. The removal of the shared part of the communication waveform may be understood as an effort to reduce overhead. Notably, shared communication information (or data), which would otherwise be carried by the shared part of the communication waveform, remains and may be carried by the sensing waveform.

With a goal of carrying data with a sensing waveform, aspects of the present application relate to creating a set of sensing waveforms with relatively good ambiguity function properties. There are several sequences that are known to be used for sensing. In general, it may be considered that a relatively good sensing waveform is a sensing waveform with a low peak side-lobe level and a low integrated side-lobe level in an auto-correlation function. For one example, chirp waveforms may be shown to have relatively low correlation side-lobe levels and may be shown to be mostly tolerant to Doppler frequency shifts. A set of chirp waveforms with different chirp rates may be selected. The various chirp rates may then be mapped to various shared communication information symbols. For another example, a sensing waveform may be created by a well-known P4 sequence. A sensing waveform created in this way is known to have a low peak correlation side-lobe level.

Symbols of shared communication information may be mapped to waveforms in a sensing waveform set such that use of a specific sensing waveform, from among the waveforms in the sensing waveform set, indicates a particular shared communication information symbol, among a set of shared communication information symbols. Notably, since the shared part of the communication waveform is typically low-rate, the set of shared communication information symbols need not be very large. It follows that the number of waveforms in the sensing waveform set, which map to the shared communication information symbols, also need not be very large.

During system operation, when the TRP 170 intends to transmit a particular shared communication information symbol, the TRP 170 may employ the sensing waveform that corresponds, in the mapping, to the particular shared communication information symbol. The shared communication information symbols may be considered to be modulated by the choice, made at the TRP 170, of a sensing waveform.

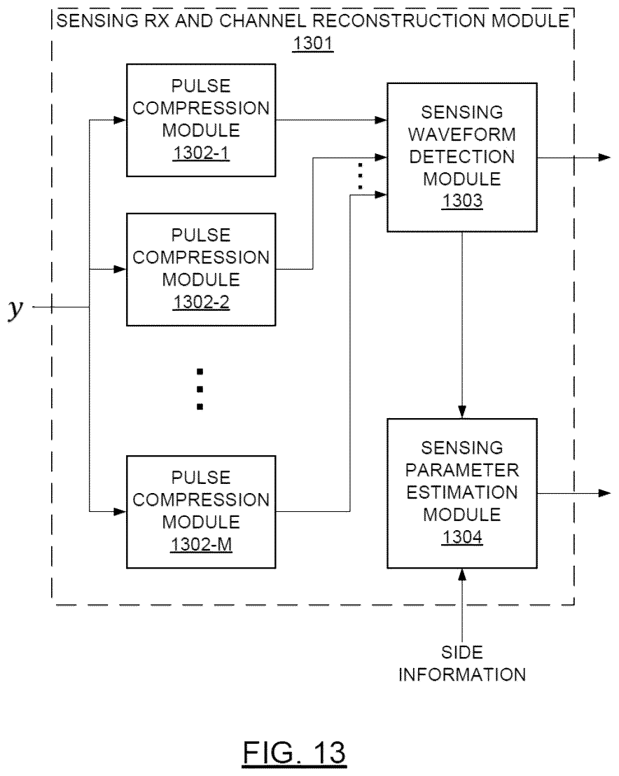

A UE 110 that is configured to receive shared communication information symbols through the use of sensing waveforms may include a sensing receiver and channel reconstruction module 1301 as illustrated in FIG. 13. As illustrated, the sensing receiver and channel reconstruction module 1301 includes a pulse compression module 1302-1 corresponding to a first sensing waveform, a pulse compression module 1302-2 corresponding to a second sensing waveform and a pulse compression module 1302-M corresponding to an M^{th} sensing waveform. It may be understood that there is a pulse compression module 1302 corresponding to each sensing waveform in the sensing waveform set. Output from the plurality of pulse compression modules 1302 is received at a sensing waveform detection module 1303.

The sensing receiver and channel reconstruction module 1301 at the UE 110 detects the sensing waveform by applying, to a received waveform, a pulse compression specific to each sensing waveform in the sensing waveform set. Signaling may be used, by the TRP 170, to share the sensing waveform set with a plurality of UEs 110. Indeed, signaling may be used to share, with the plurality of UEs 110, a codebook that establishes the mapping between each sensing waveform and a particular shared communication information symbol.

In operation, the sensing waveform detection module 1303 may detect which sensing waveform, among the sensing waveforms in the sensing waveform set, has been received based on receipt of a result of the processing of the received waveform at each of the plurality of pulse compression modules 1302. The sensing waveform detection module 1303 may output an indication of a shared communication information symbol that corresponds to the detected sensing waveform. The sensing waveform detection module 1303 may also provide output to a sensing parameter estimation module 1304. Based on the output provided by the sensing waveform detection module 1303 and, perhaps, side information, the sensing parameter estimation module 1304 may obtain an estimate of parameters, such as delay, angle and Doppler shift.

One cost of this aspect of the present application is that the sensing receiver and channel reconstruction module 1301 is more complex than it would be for situations wherein a pulse compression module is not used for every sensing waveform in the codebook.

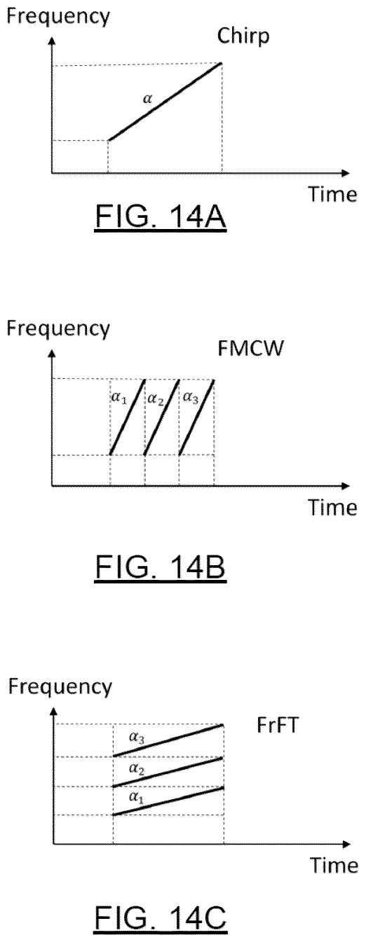

There are a number of possibilities for the sensing waveform (signal). As illustrated in FIG. 14A, the sensing waveform (signal) may be implemented as a single chirp signal with a chirp rate. As illustrated in FIG. 14B, the sensing waveform (signal) may be implemented as a plurality of chirp signals in the time domain. The sensing waveform (signal) illustrated in FIG. 14B is formally known as FMCW signal. In a general form, each chirp signal, in the plurality of chirp signals in the FMCW implementation, may have a different chirp rate. As illustrated in FIG. 14C, the sensing waveform (signal) may be implemented as a plurality of chirp signals in the frequency domain using fractional Fourier transform (FrFT). In a general form, each chirp signal, in the plurality of chirp signals in the FrFT implementation, may have a different chirp rate. In the case illustrated in FIG. 14C, the plurality of chirps may be described as being parallel in time and stacked in frequency.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
transmitting, by a base station to a user equipment (UE), a first indication indicating that a particular unit of time-frequency resources, among a plurality of units of time-frequency resources, has been allocated to sensing and communication;
transmitting, by the base station to the UE, a second indication indicating a sensing waveform configuration for the particular unit of time-frequency resources, the sensing waveform configuration indicating an allocation of power to a radio frequency (RF) sensing waveform in an integrated waveform; and
transmitting, by the base station, a signal according to the integrated waveform, wherein the integrated waveform includes the RF sensing waveform and an RF communication waveform, and wherein the power is allocated to the RF sensing waveform in accordance with the sensing waveform configuration.

2. The method of claim 1, wherein the RF sensing waveform comprises a frequency-modulated continuous wave waveform.

3. The method of claim 2, wherein the sensing waveform configuration further indicates a chirp rate.

4. The method of claim 1, wherein the RF sensing waveform comprises a fractional Fourier transform waveform.

5. The method of claim 1, further comprising:
generating a baseband sensing waveform; and
constructing the RF sensing waveform from the baseband sensing waveform.

6. The method of claim 1, further comprising:
directly generating the RF sensing waveform.

7. The method of claim 1, further comprising:
generating the integrated waveform by adding the RF communication waveform to the RF sensing waveform.

8. The method of claim 1, further comprising generating the integrated waveform by:
adding a baseband communication waveform to a baseband sensing waveform to form a baseband integrated waveform, wherein power is allocated to the baseband sensing waveform in accordance with the sensing waveform configuration; and
converting the baseband integrated waveform to an RF integrated waveform.

9. An apparatus comprising:
a memory storing instructions; and
at least one processor caused, by executing the instructions, to cause the apparatus to:
transmit a first indication indicting that a particular unit of time-frequency resources, among a plurality of units of time-frequency resources, has been allocated to sensing and communication;
transmit a second indication indicating a sensing waveform configuration for the particular unit of time-frequency resources, the sensing waveform configuration indicating an allocation of power to a radio frequency (RF) sensing waveform in an integrated waveform; and
transmit a signal according the integrated waveform, wherein the integrated waveform includes the RF sensing waveform and an RF communication waveform, and wherein the power is allocated to the RF sensing waveform in accordance with the sensing waveform configuration.

10. The apparatus of claim 9, wherein the RF sensing waveform comprises a frequency-modulated continuous wave waveform.

11. The apparatus of claim 10, wherein the sensing waveform configuration further indicates a chirp rate.

12. The apparatus of claim 9, wherein the RF sensing waveform comprises a fractional Fourier transform waveform.

13. The apparatus of claim 9, wherein the at least one processor is further caused, by executing the instructions, to cause the apparatus to:
generate a baseband sensing waveform; and
construct the RF sensing waveform from the baseband sensing waveform.

14. The apparatus of claim 9, wherein the at least one processor is further caused, by executing the instructions, to cause the apparatus to:
directly generate the RF sensing waveform.

15. The apparatus of claim 9, wherein the at least one processor is further caused, by executing the instructions, to cause the apparatus to:
generate the integrated waveform by adding the RF communication waveform to the RF sensing waveform.

16. The apparatus of claim 9, wherein the at least one processor is further caused, by executing the instructions, to cause the apparatus to generate the integrated waveform by:
adding a baseband communication waveform to a baseband sensing waveform to form a baseband integrated waveform, wherein power is allocated to the baseband sensing waveform in accordance with the sensing waveform configuration; and
converting the baseband integrated waveform to an RF integrated waveform.

17. An apparatus comprising:
a memory storing instructions; and
at least one processor caused, by executing the instructions, to cause the apparatus to:
receive a first indication indicating that a particular unit of time-frequency resources, among a plurality of units of time-frequency resources, has been allocated to sensing and communication;
receive a second indication indicating a sensing waveform configuration for the particular unit of time-frequency resources, the sensing waveform configuration indicating an allocation of power to a radio frequency (RF) sensing waveform in an integrated waveform; and
receive a signal according to the integrated waveform, wherein the integrated waveform includes the RF sensing waveform and an RF communication waveform, and wherein the power is allocated to the RF sensing waveform in accordance with the sensing waveform configuration.

18. The apparatus of claim 17, wherein the RF sensing waveform comprises a frequency-modulated continuous wave waveform.

19. The apparatus of claim 18, wherein the sensing waveform configuration further indicates a chirp rate.

20. The apparatus of claim 17, wherein the RF sensing waveform comprises a fractional Fourier transform waveform.
